(19) United States
(12) Patent Application Publication
(10) Pub. No.: US 2017/0098831 A1
(43) Pub. Date: Apr. 6, 2017

(54) CATHODE UNIT FOR CERAMIC FUEL CELL, CATHODE STRUCTURE FOR CERAMIC FUEL CELL INCLUDING THE SAME, AND METHOD OF FORMING CATHODE STRUCTURE FOR CERAMIC FUEL CELL

(71) Applicant: Korea University Research and Business Foundation, Seoul (KR)

(72) Inventor: Joon Hyung Shim, Seoul (KR)

(73) Assignee: Korea University Research and Business Foundation, Seoul (KR)

(21) Appl. No.: 15/206,371

(22) Filed: Jul. 11, 2016

(30) Foreign Application Priority Data
Oct. 5, 2015 (KR) 10-2015-0139833

(51) Int. Cl. H01M 4/90; H01M 8/1004

(52) U.S. Cl. CPC H01M 4/9066; H01M 8/1004; H01M 2004/8689

(57) ABSTRACT

A cathode unit for a ceramic fuel cell includes a silver (Ag) support and an ion conductive solid membrane. The silver (Ag) support is formed on a pellet. The ion conductive solid membrane is formed to partially cover a surface of the silver support and includes ion conductive particles electrically connected to each other and having ion conductivity.

### CROSS-REFERENCE TO RELATED APPLICATION(S)

This application claims priority under 35 USC §119 to Korean Patent Application No. 10-2015-0139833, filed on Oct. 5, 2015 in the Korean Intellectual Property Office (KIPO), the contents of which are incorporated herein in its entirety by reference.

### BACKGROUND

1. Technical Field

The present disclosure relates generally to a cathode unit for a ceramic fuel cell, a cathode structure for the ceramic fuel cell including the same, and a method of forming the same. More particularly, the present disclosure relates to a cathode unit for a ceramic fuel cell which may be applied to a cathode of the ceramic fuel cell, a cathode structure for the ceramic fuel cell including the same, and a method of forming the cathode structure for the ceramic fuel cell.

2. Description of the Related Art

A ceramic fuel cell is generally operated at a temperature of more than 800° C., and is an electrochemical power generating apparatus which generates electricity and heat from hydrogen or carbon based fuel.

Since the ceramic fuel cell is operated at a relatively high temperature, a lot of problems such as thermal stress between a stack membrane and an interconnect, sealing, additional heat supply, thermal isolation, etc., exist in use. Thus, application range of the ceramic fuel cell is limited in an auxiliary power generator, etc.

In order to solve the above problem, research for decreasing the operation temperature of the ceramic fuel cell at a middle-low temperature of less than 500° C. are actively studied.

A conventional cathode of a fuel cell uses ceramic perovskite based material in which positrons of ABO₃ structure are doped. For example, in the perovskite based material of the ABO₃ structure, A: La—Sr, Ba—Sr, Sm—Sr, etc., B: Mn, Co, Co—Fe, etc., may be prepared. However, when the cathode including the above pervoskite based ceramic material is applied to the ceramic fuel cell, the cathode has a high activation energy for oxygen reduction reaction (ORR) of 1.5 to 2.0 eV, and thus, cathode resistance at the meddle-low driving temperature is rapidly increased. Thus, efficiency of the ceramic fuel cell is low.

In order to solve the problem that the cathode has the relatively high cathode resistance, platinum or platinum alloy which has the most active material of fuel cell cathode reaction at the middle-low temperature is used. However, the platinum is expensive, and thus, economic efficiency is low.

Also, performance of a ceramic fuel cell cathode of silver or silver alloy is excellent at a temperature of low temperature range (300 to 500° C.). However, in the silver or the silver alloy, silver oxide slab is thermally decomposed at a surface thereof at a temperature of more than 300° C. Also, when the silver or the silver alloy is used as the ceramic fuel cell cathode, strong oxygen reduction reaction (ORR) is generated at an electrode-electrolyte interface. The above oxygen reduction reaction accelerates reduction reaction toward metal silver by thermal decomposition of the silver oxide on the surface.

In particular, the ceramic fuel cell cathode generally has a porous structure to efficiently diffuse oxygen gas and electro-chemically react the electrode and the electrolyte. Deformation is generated on the cathode having the above porous structure by the above-described strong oxygen reduction reaction. In order to solve the problem, research to partially decrease activity of the cathode is studied.

### SUMMARY

The present disclosure concerns a cathode unit for a ceramic fuel cell which decreases a surface energy to decrease aggregate and increase activity.

In some scenarios, a cathode structure is provided for a ceramic fuel cell which decreases a surface energy to decrease aggregate and increase activity.

The present disclosure also concerns a method of forming a cathode structure for a ceramic fuel cell which decreases a surface energy to decrease aggregate and increase activity.

In some scenarios, a cathode unit for a ceramic fuel cell includes a silver (Ag) support and an ion conductive solid membrane. The silver (Ag) support is formed on a pellet. The ion conductive solid membrane is formed to partially cover a surface of the silver support and includes ion conductive particles electrically connected to each other and having ion conductivity.

In some scenarios, the ion conductive solid membrane may have a mesh structure and/or be formed to cover 80% or less than an entire surface of the silver support.

In those or other scenarios, the ion conductive particles may include ceramic electrolyte material. For example, the ceramic electrolyte material may be composed of at least one selected from the group consisting of oxygen ion conductive ceramic material among Y:ZrO₂, Sc:ZrO₂, Gd:CeO₂, Y:CeO₂, Sm:CeO₂, Y:Bi₂O₃, and lanthanum strontium gallium magnesium oxide (LSGM), oxygen ion-electron conductive ceramic material among lanthanum strontium manganite (LSM), lanthanum strontium cobaltite (LSC), lanthanum strontium cobalt ferrite (LSCF), and barium strontium cobalt ferrite (BSCF), hydrogen ion ceramic material among Y:Ba(Sr)ZrO₃, Y:Ba(Sr)CeO₃, and Y:Ba(Sr)ZrCeO₃, and hydrogen ion-electron conductive ceramic including Y:Ba(Sr)(ZrCeFe)O₃.

A plurality of voids may be formed in the silver support. Here, the ion conductive solid membrane may have a thickness of 0.5 or less than a mean diameter of the voids.

In those or other scenarios, a cathode structure for a ceramic fuel cell includes silver supports and an ion conductive solid membrane. The silver supports are spaced apart from each other on a pellet and formed in a column shape. The ion conductive solid membrane is formed to partially cover a surface of each of the silver supports, and includes ion conductive particles electrically connected to each other and having ion conductivity.

The ion conductive solid membrane may have a thickness of 0.5 or less than a mean distance between the silver supports.

In those or other scenarios, the ion conductive solid membrane may be composed of at least one selected from the group consisting of oxygen ion conductive ceramic material among Y:ZrO₂, Sc:ZrO₂, Gd:CeO₂, Y:CeO₂, Sm:CeO₂, Y:Bi₂O₃, and lanthanum strontium gallium magnesium oxide (LSGM), oxygen ion-electron conductive ceramic material among lanthanum strontium manganite (LSM), lanthanum strontium cobaltite (LSC), lanthanum strontium cobalt ferrite (LSCF), and barium strontium cobalt ferrite (BSCF), hydrogen ion ceramic material among Y:Ba(Sr)ZrO₃, Y:Ba(Sr)CeO₃, and Y:Ba(Sr)ZrCeO₃, and hydrogen ion-electron conductive ceramic including Y:Ba(Sr)(ZrCeFe)O₃.

The present disclosure further concerns a method of forming a cathode structure for a ceramic fuel cell. Silver supports spaced apart from each other are formed on a pellet in a column shape. An ion conductive solid membrane is formed to partially cover a surface of each of the silver supports. The ion conductive solid membrane includes ion conductive particles electrically connected to each other and having ion conductivity.

In some scenarios, the ion conductive solid membrane may be formed by dispersing ion conductive nano particles in a solvent to form spraying liquid, and spraying the spraying liquid toward the silver support.

In those or other scenarios, the ion conductive solid membrane may be formed through atomic layer deposition process.

In those or other scenarios, the ion conductive solid membranes formed on a surface of a silver support are electrically connected to each other, and include ion conductive particles having ion conductivity. Thus, electrons flow through the ion conductive solid membrane as a whole. Also, oxygen ions or hydrogen ions may flow by the ion conductive particles having the ion conductivity, and thus, the ion conductive solid membrane has the ion conductivity.

Therefore, when compared with a cathode unit formed of a silver support of a column shape, the ion conductive solid membrane partially covers the silver support, so that oxygen reduction reaction is generated on an interface between the ion conductive solid membrane and the silver support. Thus, an area in which the oxygen reduction reaction is generated may be increased. Therefore, the cathode unit may have increased activity.

Furthermore, the ion conductive solid membrane is formed to partially cover the silver support, so that the cathode unit may have decreased surface energy compared with an ion conductive solid membrane only including the silver support. Thus, when a cathode structure including a plurality of cathode units is applied to the ceramic fuel cell, aggregation of the cathode structure, which is generated in the oxygen reduction reaction during operation of the ceramic fuel cell, may be decreased. As a result, deformation of the cathode unit is decreased, so that the cathode unit may maintain a stable structure.

### BRIEF DESCRIPTION OF THE DRAWINGS

Illustrative, non-limiting example embodiments will be more clearly understood from the following detailed description taken in conjunction with the accompanying drawings.

FIG. 1 is a perspective view illustrating a cathode unit for a ceramic fuel cell.

FIG. 2 is a perspective view illustrating a cathode structure for a fuel cell.

### DETAILED DESCRIPTION

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, etc. may be used herein to describe various elements, these elements should not be limited by these terms. These terms are used to distinguish one element from another. For example, a first element discussed below could be termed a second element without departing from the teachings of the present inventive concept. Also, a second element discussed below could be termed a first element without departing from the teachings of the present inventive concept. As used herein, the singular forms are intended to include the plural forms as well, unless the context clearly indicates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

Meanwhile, the terminology used herein is for the purpose of describing particular example embodiments only and is not intended to be limiting of the present inventive concept.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Cathode Unit for Ceramic Fuel Cell

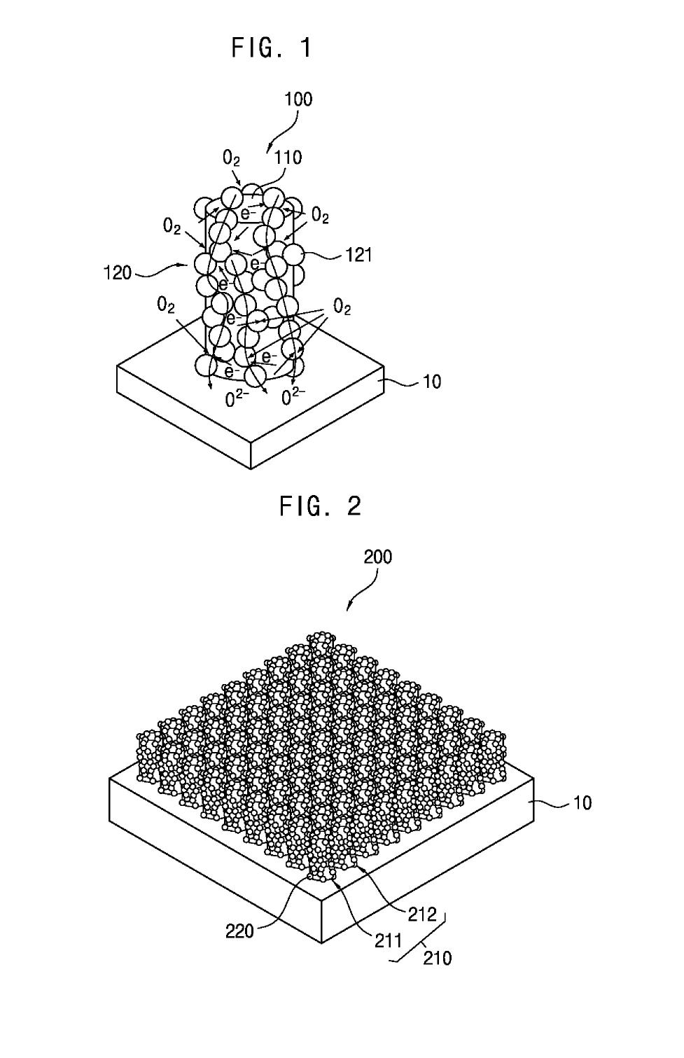

FIG. 1 is a perspective view illustrating a cathode unit for a ceramic fuel cell.

Referring to FIG. 1, the cathode unit 100 for the ceramic fuel cell includes a silver support 110 and an ion conductive solid membrane 120.

The silver support 110 is formed on a pellet 10. The silver support 110 may have a column shape. Thus, the silver support 110 has a relatively wide surface area, so that a contact area with electrolyte and oxygen gas may be increased.

The silver support 110 includes silver. The silver support 110 includes the silver to have relatively low cathode resistance at a middle temperature (300 to 500° C.), thereby having excellent activity.

The ion conductive solid membrane 120 is formed to partially cover a surface of the silver support 110. That is, the ion conductive solid membrane 120 is prepared to expose a portion of the silver support 110. Thus, oxygen gas may drain through the exposed portion of the silver support 110, so that the cathode unit 100 of the ceramic fuel cell may be effectively activated.

The ion conductive solid membrane 120 is electrically connected to each other, and includes ion conductive particles 121 having ion conductivity. Thus, the electrons may flow through the ion conductive solid membrane 120 as a whole. Also, the oxygen ions or the hydrogen ions may flow through the ion conductive particles 121, so that the ion conductive solid membrane 120 may have ion conductivity.

Thus, when compared with a cathode unit formed only of a silver support of a column shape, the ion conductive solid membrane 120 is formed to partially cover the silver support 110 to generate oxygen reduction reaction on an interface between the ion conductive solid membrane 120 and the silver support 110, so that an area in which the oxygen reduction reaction is generated may be increased. Thus, the cathode unit 100 may have increased activity.

Furthermore, the ion conductive solid membrane 120 is formed to partially cover the silver support 110 so that the silver support 110 has decreased surface energy compared with a silver support without the ion conductive solid membrane 120. Thus, when a cathode structure including a plurality of the cathode units 100 is applied to the ceramic fuel cell, aggregation of the cathode units 100, which may be generated in the oxygen reduction reaction during operation of the ceramic fuel cell, may be decreased. As a result, the deformation of the cathode unit 100 is decreased, so that the cathode unit 100 may maintain stable structure.

In some scenarios, the ion conductive solid membrane 120 may have a mesh structure. That is, the ion conductive particles in the ion conductive solid membrane 120 are connected to each other to be prepared to partially expose the surface of the silver support 110. Thus, the ion conductive solid membrane 120 may have the mesh structure or a net structure.

Here, the ion conductive solid membrane 120 may be formed to cover an area of less than or equal to 80% of the entire surface of the silver support 110. When the ion conductive solid membrane 120 is formed to cover an area of more than 80% of the entire surface of the silver support 110, the oxygen gas may not smoothly flow into the silver support 110, so that activity of the cathode unit 100 may be deteriorated.

In those or other scenarios, the ion conductive particles may include ceramic electrolyte material. For example, the ceramic electrolyte material may include any one selected from the group consisting of oxygen ion conductive ceramic material among Y:ZrO₂, Sc:ZrO₂, Gd:CeO₂, Y:CeO₂, Sm:CeO₂, Y:Bi₂O₃, and lanthanum strontium gallium magnesium oxide (LSGM), oxygen ion-electron conductive ceramic material among lanthanum strontium manganite (LSM), lanthanum strontium cobaltite (LSC), lanthanum strontium cobalt ferrite (LSCF), and barium strontium cobalt ferrite (BSCF), and Barium Strontium Cobalt Ferrite (BSCF), hydrogen ion ceramic material among Y:Ba(Sr)ZrO₃, Y:Ba(Sr)CeO₃, and Y:Ba(Sr)ZrCeO₃, and hydrogen ion-electron conductive ceramic including Y:Ba(Sr)(ZrCeFe)O₃.

In those or other scenarios, a plurality of voids may be formed in the silver support 110. Here, the ion conductive solid membrane 120 may have a thickness of less than or equal to 0.5 compared with a mean diameter of the voids. Thus, a problem of decreasing activity caused by greater thickness of the ion conductive solid membrane 120 may be prevented.

### Cathode Structure for Ceramic Fuel Cell

FIG. 2 is a perspective view illustrating a cathode structure for a fuel cell.

Referring to FIGS. 1 and 2, the cathode structure 200 for the ceramic fuel cell is formed on a pellet, and includes a plurality of silver supports 210 spaced apart from each other and ion conductive solid membranes 220 formed on surfaces of the silver supports 210.

The plurality of silver supports 210 include a first silver support 211 and a second silver support 212.

The cathode structure 200 is substantially the same as the cathode unit 100 (shown in FIG. 1) except the plurality of silver supports 210 formed on the pellet 10.

The silver supports 210 included in the ion conductive solid membrane are prepared to be spaced apart from each other. The ion conductive solid membrane has a thickness of less than or equal to 0.5 compared with a mean distance between the silver supports. Thus, a problem of decreasing activity of the cathode structure, which is caused by greater thickness of the ion conductive solid membrane, may be prevented.

Method of Forming Cathode Structure for Ceramic Fuel Cell

According to the method of forming the cathode structure for the ceramic fuel cell, silver (Ag) supports are formed on a pellet in a column shape, and are spaced apart from each other. The silver supports may be formed through a sputtering process. For example, the support may be formed on the pellet using a silver target at a DC power of 260W and under a pressure of 80 mTorr.

Then, an ion conductive solid membrane including ion conductive particles electrically connected to each other and having ion conductivity is formed to partially cover a surface of each of the silver supports.

In some scenarios, the ion conductive solid membrane may be formed through an atomic layer deposition process. For example, when the ion conductive solid membrane includes yttria-stabilized zirconia (YSZ), the atomic layer deposition process is performed at a temperature of about 250° C. using ZrO₂ and Y₂O₃ as a precursor, distilled water as an oxidation source, and nitrogen gas as a carrier gas and a purge gas, so that the ion conductive particles including YSZ may be deposited on the surfaces of the silver supports. Thus, the ion conductive solid membrane may be formed on the surfaces of the silver supports. Cycles of the atomic layer deposition process may be changed based on a thickness of the ion conductive solid membrane. For example, the atomic layer deposition process may be repeated by 7 to 15 times.

Alternatively, the ion conductive solid membrane may be formed through an injection process. In particular, ion conductive nano particles are dispersed in solvent to form a spraying liquid. The solvent may include alcohol solution. Then, the spraying liquid is sprayed on the silver support to form the ion conductive solid membrane including the ion conductive nano particles on the surfaces of the silver support.

In those or other scenarios, the ion conductive solid membranes formed on a surface of a silver support are electrically connected to each other, and include ion conductive particles having ion conductivity. Thus, electrons flow through the ion conductive solid membrane as a whole. Also, oxygen ions or hydrogen ions may flow by the ion conductive particles having the ion conductivity, and thus, the ion conductive solid membrane has the ion conductivity.

Therefore, when compared with a cathode unit formed of a silver support of a column shape, the ion conductive solid membrane partially covers the silver support, so that oxygen reduction reaction is generated on an interface between the ion conductive solid membrane and the silver support. Thus, an area in which the oxygen reduction reaction is generated may be increased. Therefore, the cathode unit may have increased activity.

Furthermore, the ion conductive solid membrane is formed to partially cover the silver support, so that the cathode unit may have decreased surface energy compared with an ion conductive solid membrane only including the silver support. Thus, when a cathode structure including a plurality of cathode units is applied to the ceramic fuel cell, aggregation of the cathode structure, which is generated in the oxygen reduction reaction during operation of the ceramic fuel cell, may be decreased. As a result, deformation of the cathode unit is decreased, so that the cathode unit may maintain a stable structure.

The cathode unit and the cathode structure of the ceramic fuel cell may be applied to the fuel cell. Also, the cathode unit and the cathode structure may be applied to catalyst or electrode material of an electrochemical product.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A cathode unit for a ceramic fuel cell, comprising:
a silver (Ag) support formed on a pellet; and
an ion conductive solid membrane formed to partially cover a surface of the silver support and including ion conductive particles electrically connected to each other and having ion conductivity.

2. The cathode unit for the ceramic fuel cell of claim 1, wherein the ion conductive solid membrane has a mesh structure.

3. The cathode unit for the ceramic fuel cell of claim 1, wherein the ion conductive solid membrane is formed to cover 80% or less than an entire surface of the silver support.

4. The cathode unit for the ceramic fuel cell of claim 1, wherein the ion conductive particles comprises ceramic electrolyte material.

5. The cathode unit for the ceramic fuel cell of claim 4, wherein the ceramic electrolyte material is composed of at least one selected from the group consisting of oxygen ion conductive ceramic material among Y:ZrO₂, Sc:ZrO₂, Gd:CeO₂, Y:CeO₂, Sm:CeO₂, Y:Bi₂O₃, and lanthanum strontium gallium magnesium oxide (LSGM), oxygen ion-electron conductive ceramic material among lanthanum strontium manganite (LSM), lanthanum strontium cobaltite (LSC), lanthanum strontium cobalt ferrite (LSCF), and barium strontium cobalt ferrite (BSCF), hydrogen ion ceramic material among Y:Ba(Sr)ZrO₃, Y:Ba(Sr)CeO₃, and Y:Ba(Sr)ZrCeO₃, and hydrogen ion-electron conductive ceramic including Y:Ba(Sr)(ZrCeFe)O₃.

6. The cathode unit for the ceramic fuel cell of claim 1, wherein a plurality of voids are formed in the silver support.

7. The cathode unit for the ceramic fuel cell of claim 6, wherein the ion conductive solid membrane has a thickness of 0.5 or less than a mean diameter of the voids.

8. A cathode structure for a ceramic fuel cell comprising:
silver supports spaced apart from each other on a pellet and formed in a column shape; and
an ion conductive solid membrane formed to partially cover a surface of each of the silver supports, and including ion conductive particles electrically connected to each other and having ion conductivity.

9. The cathode structure for the ceramic fuel cell of claim 8, wherein the ion conductive solid membrane has a thickness of 0.5 or less than a mean distance between the silver supports.

10. The cathode structure for the ceramic fuel cell of claim 8, wherein the ion conductive solid membrane is composed of at least one selected from the group consisting of oxygen ion conductive ceramic material among Y:ZrO₂, Sc:ZrO₂, Gd:CeO₂, Y:CeO₂, Sm:CeO₂, Y:Bi₂O₃, and lanthanum strontium gallium magnesium oxide (LSGM), oxygen ion-electron conductive ceramic material among lanthanum strontium manganite (LSM), lanthanum strontium cobaltite (LSC), lanthanum strontium cobalt ferrite (LSCF), and barium strontium cobalt ferrite (BSCF), hydrogen ion ceramic material among Y:Ba(Sr)ZrO₃, Y:Ba(Sr)CeO₃, and Y:Ba(Sr)ZrCeO₃, and hydrogen ion-electron conductive ceramic including Y:Ba(Sr)(ZrCeFe)O₃.

11. A method of forming a cathode structure for a ceramic fuel cell, comprising:
forming silver supports spaced apart from each other on a pellet in a column shape; and
forming an ion conductive solid membrane to partially cover a surface of each of the silver supports, the ion conductive solid membrane including ion conductive particles electrically connected to each other and having ion conductivity.

12. The method of claim 11, wherein the ion conductive solid membrane is formed by:
dispersing ion conductive nano particles in a solvent to form spraying liquid; and
spraying the spraying liquid toward the silver support.

13. The method of claim 11, wherein the ion conductive solid membrane is formed through atomic layer deposition process.
